(19) United States
(12) Patent Application Publication
(10) Pub. No.: US 2025/0131235 A1
(43) Pub. Date: Apr. 24, 2025

(54) PROGRESSIVE VIRTUAL ASSISTANT UTILIZING LARGE LANGUAGE MODEL

(71) Applicant: Vertex, Inc., King of Prussia, PA (US)

(72) Inventors: Chris Zangrilli, Collegeville, PA (US); Sal Visca, King of Prussia, PA (US); Adam B. Larabee, Dunkirk, MD (US); Ahmed Mostafa Sayed Ibrahim Gebril, Brooklyn, NY (US)

(21) Appl. No.: 18/920,777

(22) Filed: Oct. 18, 2024

Related U.S. Application Data
(60) Provisional application No. 63/592,014, filed on Oct. 20, 2023.

(51) Int. Cl. G06N 3/006; G06N 3/042; G06Q 40/12

(52) U.S. Cl. CPC G06N 3/006; G06N 3/042; G06Q 40/123

(57) ABSTRACT

A computing system for progressive virtual assistance in tax applications includes a computing device with processing circuitry configured to implement a tax application virtual assistant program. The processing circuitry is configured to receive a tax-related user query, identify an intent in the query, and select a workflow including operations required for responding to the intent. The processing circuitry is further configured to implement a workflow orchestrator to schedule a sequence of the operations, identify information needed to complete a target operation, and generate and input an information augmentation prompt to a large language model to retrieve the information. The processing circuitry is further configured to receive a response to the information augmentation prompt, generate and input a user query response prompt to the large language model, receive the user query response, and display the user query response in a chat interface.

### CROSS REFERENCE TO RELATED APPLICATIONS

The present application is based upon and claims priority under 35 U.S.C. 119 (e) to U.S. Provisional Patent Application No. 63/592,014, entitled VIRTUAL ASSISTANT FOR TAX APPLICATIONS, filed Oct. 20, 2023, the entirety of which is hereby incorporated herein by reference for all purposes.

### BACKGROUND

Computer applications can help individuals and businesses manage tasks across a variety of fields. However, working within a computer application can be confusing, particularly for users who are not familiar with technical details of the application and field-specific terminology. Configuring an application for use according to a user's needs can be complicated and time-consuming, and each user of the application may require individual training, thereby increasing the time to implementation and decreasing productivity in other areas during the training period. Further, each user may require a different level of assistance to efficiently work within the application. One particular field in which interactions with such computer applications can be complex is the field of taxation. As discussed below, opportunities exist for improving user interactions with computer applications in a variety of technical fields, including taxation.

### SUMMARY

To address these issues, systems and methods for progressive virtual assistance are disclosed herein. According to one aspect, a computing system for progressive virtual assistance in tax applications is provided. The computing system includes a computing device including processing circuitry configured to execute instructions using portions of associated memory to implement a tax application virtual assistant program. In an inference phase, the processing circuitry is configured to receive a tax-related user query via a chat interface in a turn-based dialog session, and, in response to the user query, identify at least one intent in the query based on information in the query. The processing circuitry is further configured to select a workflow from a plurality of workflows, and implement a workflow orchestrator to schedule a sequence of the plurality of operations. The selected workflow includes a plurality of operations required for responding to the at least one intent in the user query, and the workflow orchestrator includes a dependency resolver configured to determine and resolve dependencies between operations of the plurality of operations. The processing circuitry is further configured to identify information needed to complete a target operation of the plurality of operations, generate an information augmentation prompt for a large language model, the information augmentation prompt instructing the large language model to retrieve information needed to complete the target operation, input the information augmentation prompt to the large language model, and receive, as output from the large language model, a response to the information augmentation prompt. The processing circuitry is further configured to generate a user query response prompt for the large language model, the user query response prompt instructing the large language model to generate a user query response to the tax-related user query, input the user query response prompt to the large language model, receive, as output from the large language model, the user query response, and display natural language text corresponding to the user query response in the chat interface.

According to another aspect, a method for providing virtual assistance in tax applications is provided. The method includes receiving a tax-related user query via a chat interface in a turn-based dialog session, and, in response to the user query, identifying at least one intent in the query based on information in the query. The method further includes selecting a workflow from a plurality of workflows, the selected workflow including a plurality of operations required for responding to the at least one intent in the user query, and implementing a workflow orchestrator to schedule a sequence of the plurality of operations. The workflow orchestrator includes a dependency resolver configured to determine and resolve dependencies between operations of the plurality of operations. The method further includes identifying information needed to complete a target operation of the plurality of operations, and generating an information augmentation prompt for a large language model. The information augmentation prompt instructs the large language model to retrieve information needed to complete the target operation. The method further includes inputting the information augmentation prompt to the large language model, receiving, as output from the large language model, a response to the information augmentation prompt, and inputting a value for the information needed to complete the target operation to the dependency resolver. The method further includes generating a user query response prompt for the large language model. The user query response prompt instructs the large language model to generate a user query response to the tax-related user query. The method further includes inputting the user query response prompt to the large language model, receiving, as output from the large language model, the user query response, and displaying natural language text corresponding to the user query response in the chat interface.

According to another aspect, a computing system for progressive virtual assistance is provided. The computing system includes a computing device including processing circuitry configured to execute instructions using portions of associated memory to implement a virtual assistant program. In an inference phase, the processing circuitry is configured to receive a user query via a chat interface in a turn-based dialog session, and, in response to the user query, identify at least one intent in the query based on information in the query. The processing circuitry is further configured to select a workflow from a plurality of workflows, and implement a workflow orchestrator to schedule a sequence of a plurality of operations. The selected workflow includes the plurality of operations required for responding to the at least one intent in the user query, and the workflow orchestrator includes a dependency resolver configured to determine and resolve dependencies between operations of the plurality of operations. The processing circuitry is further configured to identify information needed to complete a target operation of the plurality of operations, generate an information augmentation prompt for a large language model, the information augmentation prompt instructing the large language model to retrieve information needed to complete the target operation, input the information augmentation prompt to the large language model, and receive, as output from the large language model, a response to the information augmentation prompt. The processing circuitry is further configured to generate a user query response prompt for the large language model, the user query response prompt instructing the large language model to generate a user query response to the user query, input the user query response prompt to the large language model, receive, as output from the large language model, the user query response, and display natural language text corresponding to the user query response in the chat interface. In the computing system for progressive virtual assistance, each operation of the plurality of operations is represented as a respective node in a directed acyclic graph, dependencies between the operations are represented as edges between the nodes in the directed acyclic graph, the dependency resolver queries the directed acyclic graph to determine the dependencies between the operations, and the workflow orchestrator schedules the sequence of the operations based on the dependencies between the operations.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic view of a computing system for progressive virtual assistance for computer applications, including tax applications, according to an example implementation.

FIG. 2 shows a chat interface of a virtual assistant, in accordance with the computing system of FIG. 1.

FIG. 3 shows a graphical user interface and a chat interface of a virtual assistant, in accordance with the computing system of FIG. 1.

FIG. 4 shows a chat interface of a virtual assistant, in accordance with the computing system of FIG. 1.

FIG. 5 shows a flowchart for a method for progressive virtual assistance for computer applications, including tax applications, according to an example implementation.

FIG. 6 shows a schematic view of an example computing environment in which the computing system of FIG. 1 may be enacted.

### DETAILED DESCRIPTION

Taxes are levied on numerous products, such as the production, extraction, sale, transfer, leasing, and/or delivery of goods, the rendering of services, and on the use of goods or permission to use goods or to perform activities. Tax applications can help users manage clients and handle the complexities of determining tax rates for different products, as well as for different vendors and locations. However, navigating a tax application can be complicated, and some users require more assistance and training than others when implementing the tax application.

The embodiments described herein relate to implementing a progressive virtual assistant (i.e., “Copilot”), which includes a turn-based conversational interface that can be deployed across all cloud applications. The virtual assistant may embody different interfaces and tools, depending on the application being implemented, as well as the level of assistance required by the user. The virtual assistant may focus on providing knowledge in a conversational way, enabling the user to increase and/or decrease the level of configuration automation, and performing data retrieval and task automation functions to answer user questions efficiently to assist the user in performing tasks efficiently and using the system. While the embodiments disclosed herein are described in the context of a tax application, the progressive virtual assistant may be implemented in any suitable type of application, such as applications for communication, entertainment, productivity, education, security, and finance.

It will be appreciated that the example implementations described herein and with reference to the figures are exemplary in nature and are thus not intended to limit the scope of the disclosure, as numerous variations of the provided implementations are possible.

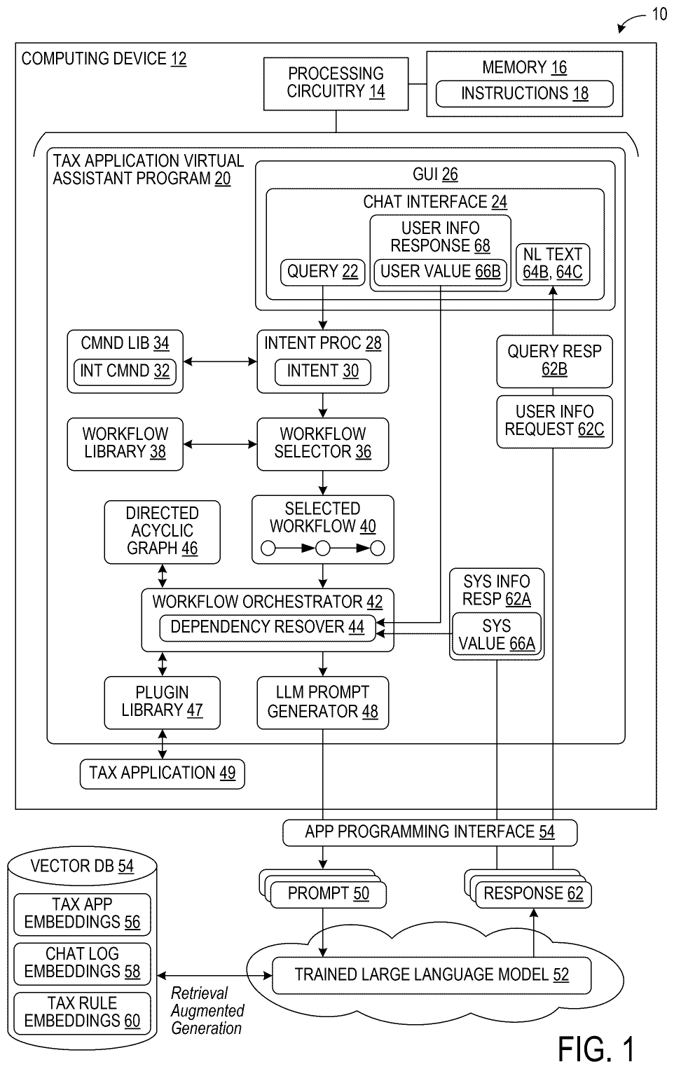

To address the issues described above, a computing system for progressive virtual assistance for tax applications is provided. As shown in FIG. 1, the computing system 10 includes a computing device 12 with processing circuitry 14 and associated memory 16. The memory 16 stores instructions 18 that cause the processing circuitry 14 to execute a tax application virtual assistant program 20. It will be appreciated that distributed processing strategies may be implemented to execute the tax application virtual assistant program 20 described herein, and the processing circuitry 14 therefore may include multiple processing devices, such as cores of a central processing unit, co-processors, graphics processing units, field programmable gate arrays (FPGA) accelerators, tensor processing units, etc., and these multiple processing devices may be positioned within one or more computing devices, and may be connected by an interconnect (when within the same device) or via a packet switched network links (when in multiple computing devices), for example. It will additionally be appreciated that the computing device 12 may be implemented as a client device, or as a server device in communication with a client device.

The tax application virtual assistant program 20 (i.e., virtual assistant) is implemented to interface with a generative model, such as trained large language model 52. The large language model can be a generative pre-trained transformer model, such as Chat-GPT 40, LLaMA, etc. In some examples, the model can be a multi-modal model configured to accept text, images, and/or audio as forms of input and configured to generate text, images, and/or audio as output.

Upon executing the tax application virtual assistant program 20 in an inference phase, the processing circuitry 14 is configured to receive a user query 22, which may be a tax-related user query when interacting with a tax application or another type of query directed to a computer application in another field. The user query 22 may be input during a turn-based dialog session via a chat interface 24 in a graphical user interface (GUI) 26 of the computing device 12. The user query 22 may be a question about configuring the tax application software, a command perform an action using the tax application, a question about the tax application product and/or features, or a request for customer support, for example. In response to the query 22, an intent processor 28 may be implemented to identify at least one intent 30 in the user query 22 based on information in the query. The intent processor 28 is trained to classify the at least one intent 30 based on a corresponding intent command 32. The corresponding intent command may be selected from a plurality of intent commands stored in a command library 34, and in accordance with predefined rules for classifying intents 30.

An example system input of predefined rules for classifying intents 30 and corresponding intent commands 32 is as follows:
“You are an AI assistant who is responsible for figuring out the next best action to take. You must classify the incoming user query in one of the provided intent commands. You can use the query, chat conversation, and the descriptions of the actions to make your decision. Here are the list of intent commands and their descriptions:
Command: add_taxpayer. Description: This is a command and should be chosen when the user commands the agent to add a taxpayer, not when the user asks a question about taxpayers. Do not use this when the user is asking a question, only when they issue a command. Keywords: add, taxpayer. Examples: Add a taxpayer for me. Please add a new taxpayer.
Command: rag_search. Description: Answers questions related to Vertex tax-related products and features only. When the user asks a technical question (‘how’, ‘where’, ‘when’, etc.) about a Vertex product, this is the proper plugin to use. Do not choose this plugin when the user is asking a casual question that doesn't seem to be related to tax or a technical product. Do not use this plugin when a user issues a command. Examples: How do I . . . . ? Where can I find X feature? What is the status of the latest release?
Command: customer_support. Description: When a user asks a question about customer support, this plugin will grab supporting information and provide a response. Keywords: customer support, contact, phone number, help, support. Examples: How do I contact customer support? If I have a question about product X, how can I get help or support? Is there a phone number that I can call to get support?
Command: chitchat. Description: Responds to small talk queries and questions such as How are you? Does not respond to questions that pertain to any topic that requires knowledge. NEVER trigger this plugin if the user query involves a subject. Examples: Hello. How are you? What's up?
Command: no_action. Description: Default plugin used when no other plugin seems right. Choose this plugin when the user asks an informal or non-serious question.
YOU CAN ONLY RETURN ONE COMMAND AND NOTHING ELSE!”

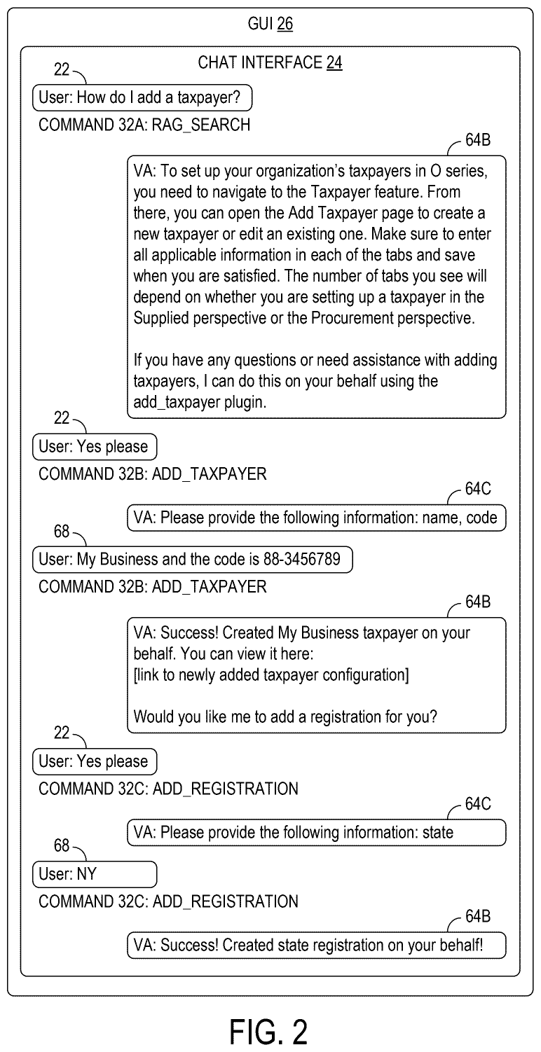

Turning briefly to FIG. 2, in the illustrated example of the chat interface 24 of the virtual assistant, the user query 22 is “How do I add a taxpayer?” The intent 30 in the query 22 was processed and classified to intent command 32A, which commands the system to perform a retrieval-augmented generation (RAG) search to retrieve the information needed to respond to the user query 22.

Returning to FIG. 1, after the intent 30 has been identified and classified to a corresponding intent command 32, a workflow selector 36 is executed to select a workflow from a plurality of workflows. The workflows may be predefined workflows stored in a workflow library 38, and each intent command 32 of the plurality of intent commands is associated with a respective one of the plurality of workflows. The selected workflow 40 includes a plurality of operations required for responding to the at least one intent 30 in the user query 22.

A workflow orchestrator 42 is then implemented to schedule a sequence of the plurality of operations. The workflow orchestrator 42 may include a dependency resolver 44 that is configured to determine and resolve dependencies between the plurality of operations. Each operation of the plurality of operations may be represented as a respective node in a directed acyclic graph (DAG) 46, and dependencies between the operations are represented as edges between the nodes in the DAG 46. The dependency resolver 44 queries the DAG 46 to determine the dependencies between the operations that are required to respond to the user query, and the workflow orchestrator 42 schedules the sequence of the operations based on the dependencies determined by the DAG query. The workflow orchestrator 42 may identify at least one plugin that is required to complete the target operation, select the plugin from a plugin library 47, and deploy the selected plugin. In some workflows 40, one or more plugins can be configured to interoperate with a tax application 49 via, e.g., an API (not shown), to perform desired operations, such as adding a taxpayer, adding a registration, etc., as discussed herein. Thus, the tax application program virtual assistant program 20 can be configured with plugins that send API commands to the tax application program 49 to perform operations in the selected workflow 40.

In determining the dependencies between the operations needed to process the user query, the dependency resolver 44 may identify that further information is needed to complete a target operation of the plurality of operations. To resolve the dependency, the workflow orchestrator 42 may trigger a large language model (LLM) prompt generator 48 to generate an information augmentation prompt 50 for an LLM 52. The information augmentation prompt 50 may be a system information prompt 50A that instructs the LLM 52 to retrieve the information needed to complete the target operation. The system information prompt 50A may be input to the LLM 52 via an application programming interface (API) 54.

An example system information prompt 50A for the tax application virtual assistant program 20 is as follows: “As a sophisticated AI, you are provided a selection of excerpts from various articles, along with a question which should be answered by one of the excerpts. Your task is to choose the best excerpt that answers the question and generate a comprehensive, concise, and accurate response. Aim to keep your communication style aligned with the context provided. Cite the source of the excerpt you chose as the primary source. If the excerpts provided do not encompass the necessary details to answer the question about Vertex products, your response should be, ‘I don't know. If you have a question about a Vertex product, I'll be happy to answer it.’ Your response must prioritize accuracy. If the excerpts provided do not carry the required specifics related to the inquiry, you should avoid conjecture. Instead, your statement should be, ‘I don't know. If you have a question about a Vertex product, I'll be happy to answer it.’” This text can be followed by a specific instruction to retrieve target information needed to complete the target operation within the system information prompt 50A, such as “Retrieve information for adding a taxpayer to O Series.”

The LLM 52 may query a vector database 54 to retrieve the information related to completing the target operation, which may be performed via a retrieval model, such as a retrieval-augmented generation (RAG). The vector database 54 may store, for example, text embeddings associated with tax application product information 56, tax application virtual assistant chat logs 58, and tax rules 60. The vector database may return a system value 66A for the information related to the target operation, which can be included in a response 62 to the system information prompt 50A that is output by the LLM 52. The response 62, which is configured as a system information response 62A, includes the value for the information related to the target operation. The system value 66A is input to the dependency resolver 44 such that the target operation can be completed, and the workflow can progress to a subsequent operation.

When each operation in the selected workflow 40 is complete, the workflow orchestrator 42 may trigger the LLM prompt generator 48 to generate a user query response prompt 50B that instructs the LLM 52 to generate a user query response 62B to the user query 22. The user query response prompt 50B is input to the LLM 52, and the user query response 62B is received as output from the LLM 52. Natural language text 64B corresponding to the user query response 62B is then generated and displayed in the chat interface 24.

In some use-case scenarios, the workflow orchestrator 42 may identify a subsequent task to be performed when the user query 22 is fulfilled. In this instance, the user query response prompt 50B instructs the LLM 52 to ask whether the subsequent task should be performed. Referring to the example in FIG. 2, the natural language text 64B corresponding to the user query response 62B describes how to add a taxpayer, and additionally suggests that the tax application virtual assistant program 20 can execute this task for the user. In the illustrated example, the user responds affirmatively, thereby effectively inputting a subsequent user query 22 that is classified to intent command 32B, which commands the system to perform an add taxpayer task to respond to the user query 22.

Turning back to FIG. 1, in some use-case scenarios, the selected workflow 36 may determine that information needed to complete the target operation will come from the user. Additionally or alternatively, the vector database 54 may fail to return a value for the information related to the target operation. In such instances, the information augmentation prompt 50 that instructs the LLM 52 to retrieve the information needed to complete the target operation may be a user information request prompt 50C that instructs the LLM 52 to generate a user information request 62C for the information related to the target operation. The user information request prompt 50C is input to the LLM 52, and the user information request 62C is output as the response 62 from the LLM 52. Natural language text 64C corresponding to the user information request 62C is then generated and displayed in the chat interface 24.

Continuing with the example in FIG. 2, natural language text 64C corresponding to the user information request 62C for a business name and tax code is displayed in the chat interface 24. A user information response 68 including a user value 66B for the information needed to complete the target operation is received in the chat interface 34, and the user value 66B is input to the dependency resolver 44 to complete the target operation. Natural language text 64B corresponding to the user query response 64B is displayed in the chat interface 24, including a question with regard to whether a further subsequent task (add a registration) should be performed. In the illustrated example, the user again responds affirmatively, and the tax application virtual assistant program 20 classifies the effective user query 22 to intent command 32C, which commands the system to perform an add registration task to respond to the user query 22. When additional information is needed from the user, natural language text 64C corresponding to the user information request 62C for a state is displayed in the chat interface 24. The user information response 68 including the user value 66B for the information needed to complete the target operation is received in the chat interface 24. As shown in FIG. 2, the example user value 66B is “NY,” which is input to the dependency resolver 44 to complete the selected workflow 40.

As described above, when each operation in the selected workflow 40 is complete, the workflow orchestrator 42 may trigger the LLM prompt generator 48 to generate a user query response prompt 50B that instructs the LLM 52 to generate a user query response 62B to the user query 22. Natural language text 64B corresponding to the user query response 62B is then generated and displayed in the chat interface 24.

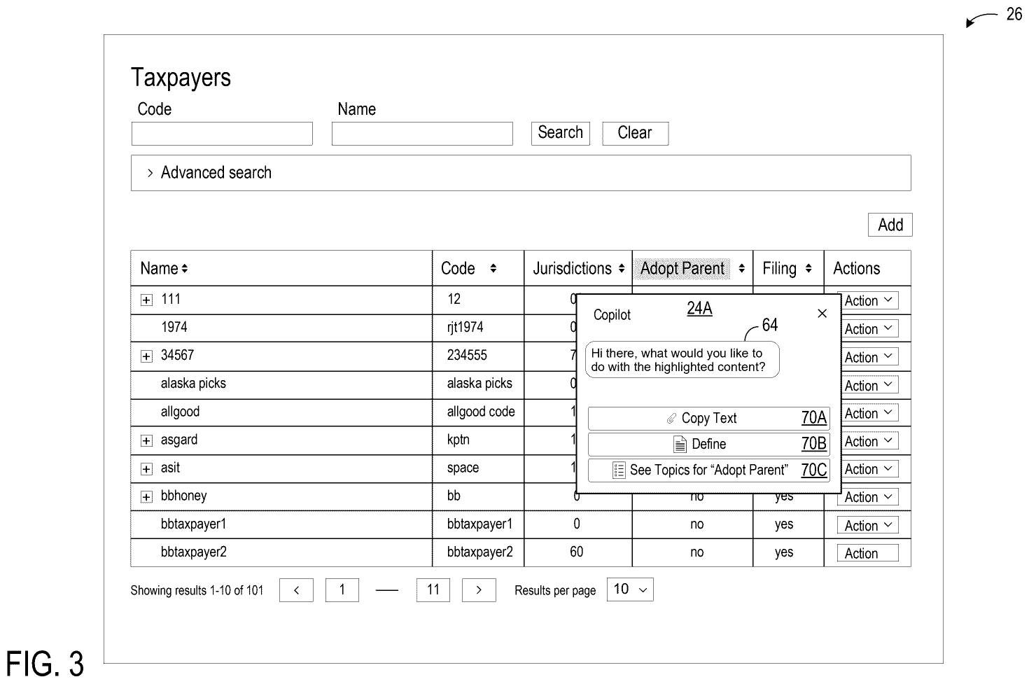

FIG. 3 shows an example embodiment of the GUI 26 of the tax application virtual assistant program 20, in which text can be highlighted to trigger an action. As illustrated in FIG. 3, the term “adopt parent” has been highlighted in the GUI 26. In response, natural language text 64 and selectors 70A-70C corresponding to actions that may be taken with regard to the highlighted term is displayed in the chat interface 24. It will be appreciated that in FIG. 3, the chat interface 24 is in a collapsed configuration 24A.

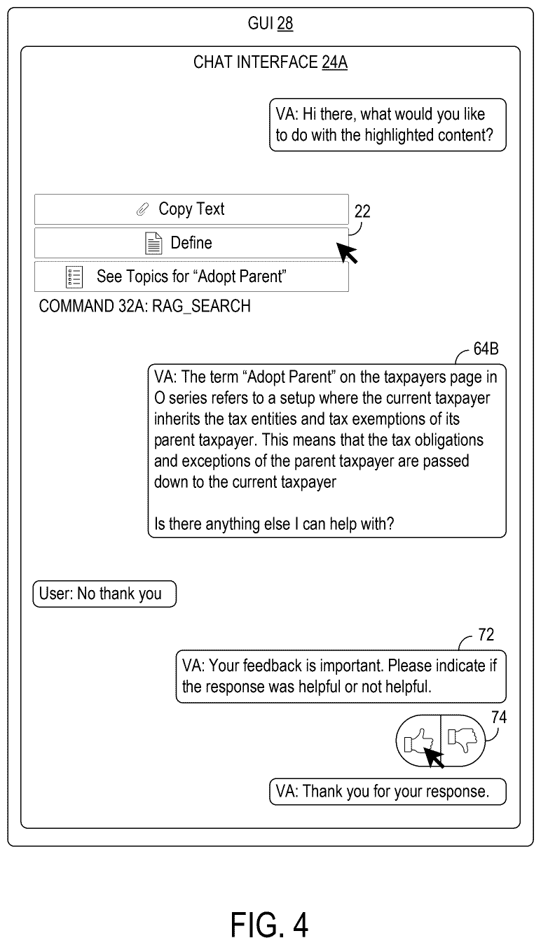

Continuing to FIG. 4, the chat interface 24 is illustrated in an expanded configuration 24B, and “define” is selected, thereby indicating a user query 22. Because the user query 22 relates to product information, it is classified to intent command 32A, which commands the system to perform a retrieval-augmented generation (RAG) search to retrieve the product information needed to respond to the user query 22. As described above, a workflow 40 is selected to perform the operations needed to respond to the user query 22, and natural language text 64B corresponding to the user query response 62B with a definition of “Adopt Parent” is displayed in the chat interface 24. When the user query 22 is satisfied and there are no further queries to respond to, the virtual assistant may be trained to display a feedback request 72 from the user regarding the user query response 62B. While the user tool 74 for responding to the feedback request 72 is illustrated as a selectable “thumbs up/thumbs down” icon in FIG. 4, it will be appreciated that the user tool 74 may be alternately embodied as a series of questions, a numerical rating tool, or a text window, for example. As shown in FIG. 4, the response to the query 22 was determined to be helpful, as indicated by the selection of the “thumbs up” icon 32 at the bottom of the chat interface 24.

By processing user responses to system inquiries, suggestions, and feedback requests, the system utilizes human-in-the-loop (HITL) to improve accuracy and train the intent processor and/or workflow selector with regard to individual user preferences. In some implementations, HITL could be triggered until a threshold number of user responses under similar circumstances has been met, then the virtual assistant can offer to skip the HITL confirmation step in subsequent similar operations. For example, if a user consistently adds a registration after adding a taxpayer, the system may ask if the user wants to automatically add a registration after adding a taxpayer, thereby leveraging robotic process automation (RPA) to increase the efficiency of tax application tasks.

The tax application virtual assistant program may further include settings that allow a user to manually select an automation level or HITL intervention level. For example, a drop down list of tasks with selectable levels of automation or HITL intervention can be provided for each task or as a horizontal bar chart representing jobs to be done (JTBD) with a user-adjustable indicator representing the automaton level or HITL intervention level for each of the JTBD. Such a feature would permit the user to select an automation level for each task based on the user's comfort with the virtual assistant program, as well as the user's skill level. Automating tasks that would be time-consuming for the user to perform can result in increased accuracy and efficiency of the tax application. Notably, the user can progressively increase automation and decrease HITL intervention as the training level and performance of the virtual assistant improve.

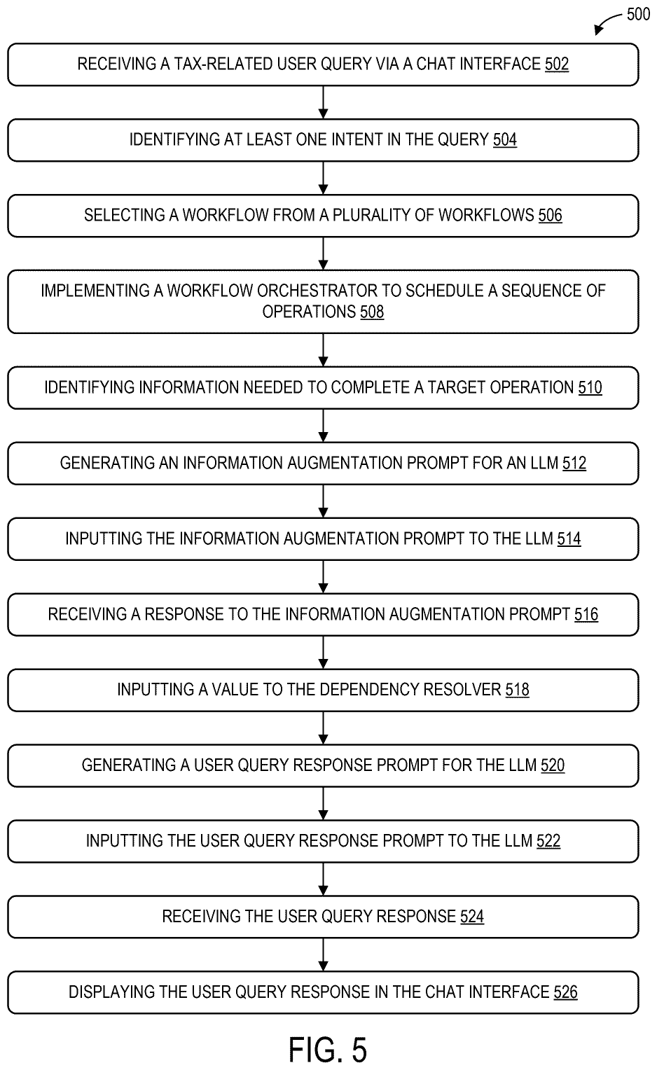

FIG. 5 shows a flowchart for a method 500 for providing virtual assistance in tax applications. The method 500 may be implemented by the computing system 10 illustrated in FIG. 1, or via other suitable hardware and software.

At step 502, the method 500 may include receiving a tax-related user query via a chat interface. As described in detail above, the tax-related user query may be received in a turn-based dialog session and may be a question about configuring the tax application software, a command perform an action using the tax application, a question about the tax application product and/or features, or a request for customer support, for example.

Continuing from step 502 to step 504, the method 500 may include identifying at least one intent in the query. An intent processor may be implemented to identify the intent in the user query based on information in the query. The intent may be classified to a corresponding intent command, and in accordance with predefined rules for classifying intents.

Proceeding from step 504 to step 506, the method 500 may include selecting a workflow from a plurality of workflows. The workflows may be predefined workflows stored in a workflow library, each of which are associated with a respective intent command. The selected workflow includes a plurality of operations required for responding to the intent in the user query.

Advancing from step 506 to step 508, the method 500 may include implementing a workflow orchestrator to schedule a sequence of the plurality of operations. A dependency resolver configured to determine and resolve dependencies between the plurality of operations may be included in the workflow orchestrator. Each operation may be represented as a respective node in a directed acyclic graph (DAG), and dependencies between the operations are represented as edges between the nodes in the DAG. The dependency resolver queries the DAG to determine the dependencies between the operations, and the workflow orchestrator schedules the sequence of the operations based on the dependencies between the operations. The workflow orchestrator may be further configured to identify at least one plugin that is required to complete the target operation, select the plugin from a plugin library, and deploy the selected plugin.

Continuing from step 508 to step 510, the method 500 may include identifying information needed to complete a target operation. The information may be related to tax application product information, customer information, vendor information, tax rules, and the like, for example.

Proceeding from step 510 to step 512, the method 500 may include generating an information augmentation prompt for a large language model. To retrieve the information needed to complete the target operation and resolve the dependency, the workflow orchestrator may trigger a large language model (LLM) prompt generator to generate a prompt that instructs the LLM to retrieve the necessary information.

Advancing from step 512 to step 514, the method 500 may include inputting the information augmentation prompt to the large language model. The information augmentation prompt may be input to the LLM via an application programming interface (API). As described above, the information augmentation prompt may be configured as a system information prompt or a user information request prompt, depending on whether the information needed to complete the target operation is determined to be system information or user information.

Continuing from step 514 to step 516, the method 500 may include receiving, as output from the large language model, a response to the information augmentation prompt. The response may be a system information response or a user information request. The system information response may include a system value for the information related to the target operation that was retrieved from text embeddings associated with tax application product information, tax application virtual assistant chat logs, and tax rules stored in a vector database, for example. When the response is a user information request, natural language text corresponding to the user information request is displayed in the chat interface, and a user information response including a user value for the information needed to complete the target operation is received in the chat interface.

Proceeding from step 516 to step 518, the method 500 may include inputting a value for the information needed to complete the target operation to the dependency resolver. As discussed above, the value may be a system value included in the system information response or a user value included in the user information response.

Advancing from step 518 to step 520, the method 500 may include generating a user query response prompt for the large language model. When each operation in the selected workflow is complete, the workflow orchestrator may trigger the LLM prompt generator to generate a user query response prompt to generate a user query response to the tax-related user query.

Continuing from step 520 to step 522, the method 500 may include inputting the user query response prompt to the large language model.

Proceeding from step 522 to step 524, the method 500 may include receiving, as output from the large language model, the user query response.

Advancing from step 524 to step 526, the method 500 may include displaying natural language text corresponding to the user query response in the chat interface. The workflow orchestrator may identify a subsequent task to be performed when the user query is fulfilled, and the user query response may include asking whether the subsequent task should be performed.

Using the above described systems and methods, the progressive virtual assistant for tax applications can guide users through a continuum of capabilities that can be increased or decreased depending on a user's need and comfort level. System capabilities include retrieving tax processing rules and tax application configuration information, supporting user-specific configuration of the tax application, setting up configuration information, translating user terminology to and from the tax terminology, and automatically performing actions in accordance with user preferences and settings. Once configured, aspects of the tax application can be shared with colleagues who have not yet been trained on the tax application, thereby decreasing training time and improving productivity.

Additionally, the virtual assistant may function as a tool to automate the creation of test cases for the user to test their configuration changes with the products in the portfolio. Such an implementation may include the ability to automate the execution of the test cases with the goal of reducing the time to create, maintain, and execute configuration testing. Further, the virtual assistant may provide tax category assistance in the retail segment, which often requires bulk and frequent taxability category classifications, thereby reducing the time required to assign products to tax categories and improving productivity. Finally, the virtual assistant may map client APIs to tax technology software APIs, generate sample code, and generate test harnesses/test cases, which may reduce the time needed to implement the tax technology software on a client system, therefore improving productivity.

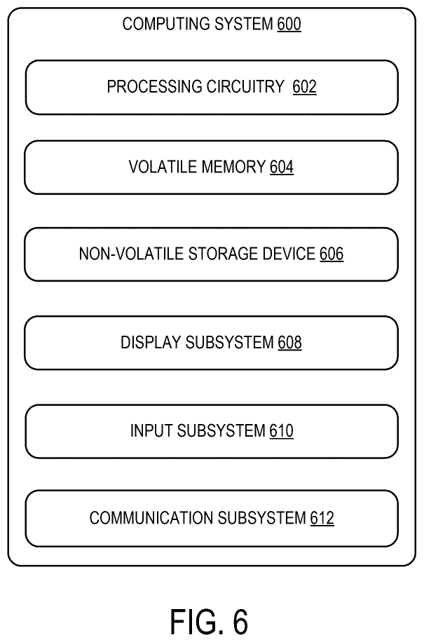

FIG. 6 schematically shows a non-limiting embodiment of a computing system 600 that can enact one or more of the methods and processes described above. Computing system 600 is shown in simplified form. Computing system 600 may embody the computing system 10 described above and illustrated in FIG. 1. Components of computing system 600 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 600 includes processing circuitry 602, volatile memory 604, and a non-volatile storage device 606. Computing system 600 may optionally include a display subsystem 608, input subsystem 610, communication subsystem 612, and/or other components not shown in FIG. 6.

Processing circuitry typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 602 may be single-core or multi-core, and the instructions executed thereon may be configured for sequential, parallel, and/or distributed processing. Individual components of the processing circuitry optionally may be distributed among two or more separate devices, which may be remotely located and/or configured for coordinated processing. For example, aspects of the computing system disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 602.

Non-volatile storage device 606 includes one or more physical devices configured to hold instructions executable by the processing circuitry to implement the methods and processes described herein. When such methods and processes are implemented, the state of non-volatile storage device 606 may be transformed—e.g., to hold different data.

Non-volatile storage device 606 may include physical devices that are removable and/or built in. Non-volatile storage device 606 may include optical memory, semiconductor memory, and/or magnetic memory, or other mass storage device technology. Non-volatile storage device 606 may include nonvolatile, dynamic, static, read/write, read-only, sequential-access, location-addressable, file-addressable, and/or content-addressable devices. It will be appreciated that non-volatile storage device 606 is configured to hold instructions even when power is cut to the non-volatile storage device 606.

Volatile memory 604 may include physical devices that include random access memory. Volatile memory 604 is typically utilized by processing circuitry 602 to temporarily store information during processing of software instructions. It will be appreciated that volatile memory 604 typically does not continue to store instructions when power is cut to the volatile memory 604.

Aspects of processing circuitry 602, volatile memory 604, and non-volatile storage device 606 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 600 typically implemented in software by a processor to perform a particular function using portions of volatile memory, which function involves transformative processing that specially configures the processor to perform the function. Thus, a module, program, or engine may be instantiated via processing circuitry 602 executing instructions held by non-volatile storage device 606, using portions of volatile memory 604. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 608 may be used to present a visual representation of data held by non-volatile storage device 606. The visual representation may take the form of a graphical user interface (GUI). As the herein described methods and processes change the data held by the non-volatile storage device, and thus transform the state of the non-volatile storage device, the state of display subsystem 608 may likewise be transformed to visually represent changes in the underlying data. Display subsystem 608 may include one or more display devices utilizing virtually any type of technology. Such display devices may be combined with processing circuitry 602, volatile memory 604, and/or non-volatile storage device 606 in a shared enclosure, or such display devices may be peripheral display devices.

When included, input subsystem 610 may comprise or interface with one or more user-input devices such as a keyboard, mouse, touch screen, camera, or microphone.

When included, communication subsystem 612 may be configured to communicatively couple various computing devices described herein with each other, and with other devices. Communication subsystem 612 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 600 to send and/or receive messages to and/or from other devices via a network such as the Internet.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for progressive virtual assistance in tax applications, the computing system comprising:
a computing device including processing circuitry configured to execute instructions using portions of associated memory to implement a tax application virtual assistant program, wherein the processing circuitry is configured to:
in an inference phase:
receive a tax-related user query via a chat interface in a turn-based dialog session;
in response to the user query, identify at least one intent in the query based on information in the query;
select a workflow from a plurality of workflows, the selected workflow including a plurality of operations required for responding to the at least one intent in the user query;
implement a workflow orchestrator to schedule a sequence of the plurality of operations, the workflow orchestrator including a dependency resolver configured to determine and resolve dependencies between operations of the plurality of operations;
identify information needed to complete a target operation of the plurality of operations;
generate an information augmentation prompt for a large language model, the information augmentation prompt instructing the large language model to retrieve information needed to complete the target operation;
input the information augmentation prompt to the large language model;
receive, as output from the large language model, a response to the information augmentation prompt;
input a value for the information needed to complete the target operation to the dependency resolver;
generate a user query response prompt for the large language model, the user query response prompt instructing the large language model to generate a user query response to the tax-related user query;
input the user query response prompt to the large language model;
receive, as output from the large language model, the user query response; and
display natural language text corresponding to the user query response in the chat interface.

2. The computing system of claim 1, wherein
each operation of the plurality of operations is represented as a respective node in a directed acyclic graph,
dependencies between the operations are represented as edges between the nodes in the directed acyclic graph,
the dependency resolver queries the directed acyclic graph to determine the dependencies between the operations, and
the workflow orchestrator schedules the sequence of the operations based on the dependencies between the operations.

3. The computing system of claim 1, wherein
the workflow orchestrator identifies at least one plugin that is required to complete the target operation, and
the workflow orchestrator selects the at least one plugin from a plugin library and deploys the selected plugin.

4. The computing system of claim 2, wherein
the workflow orchestrator identifies a subsequent task to be performed when the user query is fulfilled, and
the user query response prompt instructs the large language model to ask whether the subsequent task should be performed.

5. The computing system of claim 1, further comprising:
a vector database storing text embeddings associated with tax application product information, tax application virtual assistant chat logs, and tax rules, wherein
the information augmentation prompt is configured as a system information prompt,
the large language model queries the vector database to retrieve information related to the target operation,
the vector database returns a system value for the information related to the target operation,
the response output from the large language model is a system information response including the system value retrieved from the vector database, and
the system value is input to the dependency resolver such that the target operation can be completed, and the workflow can progress to a subsequent operation.

6. The computing system of claim 1, wherein
the information augmentation prompt is configured as a user information request prompt,
the response output from the large language model is a user information request,
natural language text corresponding to the user information request is displayed in the chat interface,
a user information response including a user value for the information needed to complete the target operation is received in the chat interface, and
the user value is input to the dependency resolver such that the target operation can be completed, and the workflow can progress to a subsequent operation.

7. The computing system of claim 6, wherein,
the large language model is configured to retrieve information from the vector database via retrieval-augmented generation.

8. The computing system of claim 1, wherein
the intent processor is trained to classify the at least one intent based on a corresponding intent command selected from a plurality of intent commands, and in accordance with predefined rules for classifying intents.

9. The computing system of claim 8, wherein
each intent command of the plurality of intent commands is associated with a respective one of the plurality of workflows, the workflows being predefined workflows stored in a workflow library.

10. A method for providing virtual assistance in tax applications, the method comprising:
receiving a tax-related user query via a chat interface in a turn-based dialog session;
in response to the user query, identifying at least one intent in the query based on information in the query;
selecting a workflow from a plurality of workflows, the selected workflow including a plurality of operations required for responding to the at least one intent in the user query;
implementing a workflow orchestrator to schedule a sequence of the plurality of operations, the workflow orchestrator including a dependency resolver configured to determine and resolve dependencies between operations of the plurality of operations;
identifying information needed to complete a target operation of the plurality of operations;
generating an information augmentation prompt for a large language model, the information augmentation prompt instructing the large language model to retrieve information needed to complete the target operation;
inputting the information augmentation prompt to the large language model;
receiving, as output from the large language model, a response to the information augmentation prompt;
inputting a value for the information needed to complete the target operation to the dependency resolver;
generating a user query response prompt for the large language model, the user query response prompt instructing the large language model to generate a user query response to the tax-related user query;
inputting the user query response prompt to the large language model;
receiving, as output from the large language model, the user query response; and
displaying natural language text corresponding to the user query response in the chat interface.

11. The method of claim 10, the method further comprising:
representing each operation of the plurality of operations as a respective node in a directed acyclic graph;
representing dependencies between the operations as edges between the nodes in the directed acyclic graph;
querying, at the dependency resolver, the directed acyclic graph to determine the dependencies between the operations; and
scheduling, at the workflow orchestrator, the sequence of the operations based on the dependencies between the operations.

12. The method of claim 11, the method further comprising:
at the workflow orchestrator:
identifying at least one plugin that is required to complete the target operation;
selecting the at least one plugin from a plugin library; and
deploying the selected plugin.

13. The method of claim 11, the method further comprising:
identifying a subsequent task to be performed when the user query is fulfilled; and
instructing, via the user query response prompt, the large language model to ask whether the subsequent task should be performed.

14. The method of claim 10, the method further comprising:
storing text embeddings associated with tax application product information, tax application virtual assistant chat logs, and tax rules in a vector database;
configuring the information augmentation prompt as a system information prompt;
querying, at the large language model, the vector database to retrieve a system value for the information related to the target operation;
in response to querying the vector database, receiving a system information response from the large language model, the system information response including the system value for the information related to the target operation; and
inputting the system value to the dependency resolver such that the target operation can be completed, and the workflow can progress to a subsequent operation.

15. The method of claim 10, the method further comprising:
configuring the information augmentation prompt as a system information prompt;
receiving a user information request from the large language model;
displaying natural language text corresponding to the user information request in the chat interface;
receiving, in the chat interface, a user information response including a user value for the information needed to complete the target operation; and
inputting the user value to the dependency resolver such that the target operation can be completed, and the workflow can progress to a subsequent operation.

16. The method of claim 15, the method further comprising:
configuring the large language model to retrieve information from the vector database via retrieval-augmented generation.

17. The method of claim 10, the method further comprising:
classifying the at least one intent based on a corresponding intent command selected from a plurality of intent commands, and in accordance with predefined rules for classifying intents.

18. The method of claim 17, the method further comprising:
associating each intent of the plurality of intents with a respective one of the plurality of workflows; and
storing the workflows as predefined workflows in a workflow library.

19. A computing system for progressive virtual assistance, the computing system comprising:
a computing device including processing circuitry configured to execute instructions using portions of associated memory to implement a virtual assistant program, wherein the processing circuitry is configured to:
in an inference phase:
receive a user query via a chat interface in a turn-based dialog session;
in response to the user query, identify at least one intent in the query based on information in the query;
select a workflow from a plurality of workflows, the selected workflow including a plurality of operations required for responding to the at least one intent in the user query;
implement a workflow orchestrator to schedule a sequence of the plurality of operations, the workflow orchestrator including a dependency resolver configured to determine and resolve dependencies between operations of the plurality of operations;
identify information needed to complete a target operation of the plurality of operations;
generate an information augmentation prompt for a large language model, the information augmentation prompt instructing the large language model to retrieve information needed to complete the target operation;
input the information augmentation prompt to the large language model;
receive, as output from the large language model, a response to the information augmentation prompt;
input a value for the information needed to complete the target operation to the dependency resolver;
generate a user query response prompt for the large language model, the user query response prompt instructing the large language model to generate a user query response to the user query;
input the user query response prompt to the large language model;
receive, as output from the large language model, the user query response; and
display natural language text corresponding to the user query response in the chat interface, wherein
each operation of the plurality of operations is represented as a respective node in a directed acyclic graph,
dependencies between the operations are represented as edges between the nodes in the directed acyclic graph,
the dependency resolver queries the directed acyclic graph to determine the dependencies between the operations, and
the workflow orchestrator schedules the sequence of the operations based on the dependencies between the operations.

20. The computing system of claim 19, wherein
the intent processor is trained to classify the at least one intent based on a corresponding intent command selected from a plurality of intent commands, and
each intent command of the plurality of intent commands is associated with a respective one of the plurality of workflows.
